(19) United States
(12) Patent Application Publication
(10) Pub. No.: US 2009/0048920 A1
(43) Pub. Date: Feb. 19, 2009

(54) Method for Improving Internet Advertising by Intermittently Mixing Advertising with Targeted Content

(76) Inventors: Kashyap Lodhiya, Santa Clara, CA (US); Julie Cheng, Los Gatos, CA (US); Mohit Vora, Mountain View, CA (US); Nicholas Clark, San Jose, CA (US)

Correspondence Address: STATTLER - SUH PC, 60 SOUTH MARKET STREET, SUITE 480, SAN JOSE, CA, 95113, US

(21) Appl. No.: 11/839,924

(22) Filed: Aug. 16, 2007

(51) Int. Cl. G06Q 30/00

(52) U.S. Cl. 705/14

(57) ABSTRACT

A system engaging users with internet advertisement areas using interesting content is presented. Areas normally devoted to internet advertisements are periodically replaced with engaging content. In one embodiment, RSS web feeds are used to obtain recent and summarized bits of engaging content to place in the advertising areas. In yet another embodiment, hybrid mixes of engaging content and advertisements are displayed. In this manner, internet viewers remain engaged with the areas on an internet web page that are normally devoted to internet advertisements.

### FIELD OF THE INVENTION

The present invention relates to the field of advertising on the internet. In particular the present invention discloses techniques for improving the viewership of internet advertisements by intermittently mixing desirable content in advertisement locations.

### BACKGROUND OF THE INVENTION

The global Internet has become a form of mass media on par with radio and television. And just like radio and television content, the rich and interesting content on the Internet is largely supported by advertising dollars. The main advertising-supported portion of the Internet is the “World Wide Web” that displays HyperText Mark-Up Language (HTML) documents distributed using the HyperText Transport Protocol (HTTP).

Two of the most common types of advertisements on the World Wide Web portion of the Internet are banner advertisements and text link advertisements. A banner advertisement generally consists of an image or animation that is displayed within an Internet web page. Text link advertisements are generally short segments of text displayed within a designated advertisement area in a web page. Both banner advertisements and text link advertisements are linked to a web site designated by the advertiser.

As with radio and television advertisements, web viewers have learned to “tune-out” the advertisements and instead focus on the main content in a web page. Since it is the advertising revenue that pays for main content, it is very important to keep web viewers engaged with the internet advertisements such that internet advertisers will continue to fund advertising supported web sites. Thus, it would be very desirable to improve upon the advertisements presented to internet viewers in order to keep the internet viewers engaged with the advertisements presented on internet web sites.

### SUMMARY OF THE INVENTION

The present invention introduces methods for keeping internet viewers engaged with internet advertisements. Areas normally devoted to internet advertisements are periodically replaced with engaging content. In one embodiment, RSS web feeds are used to obtain recent and summarized bits of engaging content to place in the advertising areas. In yet another embodiment, hybrid mixes of engaging content and advertisements are displayed. In this manner, internet viewers remain engaged with the areas on internet web pages that are normally devoted to internet advertisements. By using engaging content, the system of the present invention does not harm the viewer experience. Furthermore, the engaging content can be presented in a matter that provides commercial advantages.

Other objects, features, and advantages of present invention will be apparent from the accompanying drawings and from the following detailed description.

### BRIEF DESCRIPTION OF THE DRAWINGS

The objects, features, and advantages of the present invention will be apparent to one skilled in the art, in view of the following detailed description in which:

FIG. 1 illustrates a conceptual diagram of an internet viewer at a personal computer system accessing an internet web site that is supported by an internet advertising service.

FIG. 2A illustrates an example of an “internet portal” web site home page.

FIG. 2B illustrates the example of internet portal web site home page of FIG. 2A wherein an area normally used to display advertisements displays a set of Major League Baseball scores.

FIG. 2C illustrates the example of internet portal web site home page of FIG. 2A wherein an area normally used to display advertisements displays a set of active stocks.

FIG. 2D illustrates the example of internet portal web site home page of FIG. 2A wherein an area normally used to display advertisements displays a list of movies at the top of the box office charts.

FIG. 2E illustrates the example of internet portal web site home page of FIG. 2A wherein an area normally used to display advertisements display a hybrid mix of engaging content and advertisements.

FIG. 3 illustrates a high-level flow diagram of how engaging content may be intermittently placed into areas normally devoted to advertising.

### DETAILED DESCRIPTION

Methods for engaging internet viewers with advertisement areas using interesting content are disclosed. In the following description, for purposes of explanation, specific nomenclature is set forth to provide a thorough understanding of the present invention. However, it will be apparent to one skilled in the art that these specific details are not required in order to practice the present invention. For example, although the present invention is mainly disclosed with reference to advertisements placed on web sites on the World Wide Web aspect of the internet, the same techniques can easily be applied in other situations. Specifically, the techniques of the present invention can be used in any application that selects electronic advertisements for display. Thus, the techniques of the present invention could be used in other electronic advertisement selection applications.

### Advertising Support for Commercial World Wide Web Sites

The World Wide Web portion of the global Internet has become a mass media that largely operates using advertiser sponsored web sites. Specifically, web site publishers provide interesting content that attracts web site viewers and the publisher intersperses paid advertisements into the web pages of the web site. The fees from the advertisers compensate the web site publisher for creating the interesting content that attracts the web viewers.

Some internet web site advertisements are ‘banner advertisements’ consisting of an advertiser-supplied image or animation. Other internet web site advertisements merely consist of simple short strings of text. However, one thing that most internet web site advertisements have in common is that the internet web site advertisements contain a hyperlink (link) to another web site such that the person viewing the internet advertisement may click on the advertisement to be directed to the advertiser's web site to obtain more information.

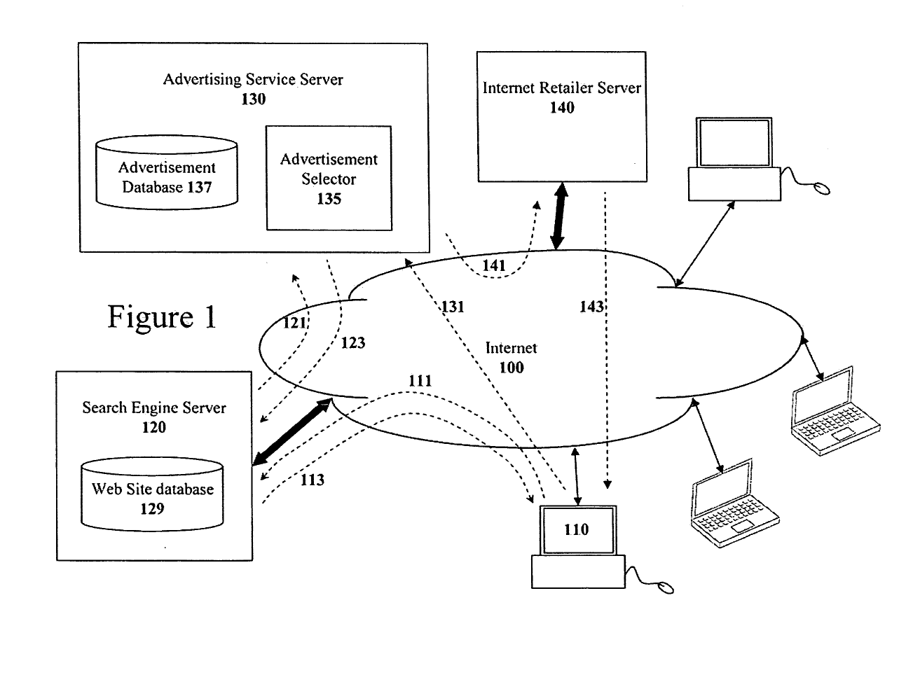

The advertisements within an advertising supported web site are generally provided to the web site publisher by an external internet advertising service. FIG. 1 illustrates a conceptual diagram of how an internet advertising service and a web site publisher interact with each other. Referring to FIG. 1, an internet-based retailer server 140 that sells products to internet-based customers may Sign up with an internet advertisement service 130 in order to promote the web site of the internet based retailer 140. When an internet viewer at personal computer 110 is browsing a web site published by web site publisher server 120, the internet viewer may be exposed to an advertisement from internet advertisement service 130 that advertises the retail offerings of the internet retailer 140.

If the internet viewer at personal computer 110 is sufficiently interested in the advertisement, the internet viewer at personal computer 110 may click on the advertisement. When such an internet viewer click occurs, internet advertisement service 130 will record the internet viewer's click on the advertisement such that the internet advertisement service 130 may bill internet retailer server 140 for the selection of the advertisement. Internet advertisement service 130 then re-directs the internet viewer's web browser to the internet retailer server 140. Once the internet viewer at personal computer 110 has been re-directed to the internet retailer server 140, the internet viewer may then purchase goods or services directly from the internet retailer server 140.

Since the business of web site publisher server 120 (and the business of internet advertisement service 130 are wholly dependent, on internet advertising, it is critical to ensure that internet viewers that visit advertising supported web sites view the internet advertisements displayed to those internet viewers. Furthermore, the internet viewers need to be engaged with such advertisements such that they click tip on those advertisements at least occasionally.

One method that has been used by internet advertisements to attract the attention of internet viewers is to carefully select internet advertisements that will likely be of interest to the internet viewers. For example, internet search engines will use the keywords entered by the search engine users to select internet advertisements that will be displayed with the search results. Furthermore, content-match advertisement selection systems have been developed that carefully select internet advertisements to closely match the content of the web pages of advertising supported web sites. With such intelligent internet advertisement selection systems, an internet viewer will be more likely to click on a displayed internet advertisement if the internet viewer looks at the internet advertisement.

However, for intelligent internet advertisement selection systems to work effectively, the internet viewer must still actually look at the advertisement. If an internet viewer never bothers to look at an internet advertisement, it will make no difference on how well-tailored that advertisement is for that particular internet viewer. An internet viewer will simply not click on an advertisement that was never looked at.

### Engaging Internet Viewers with Intermittent Targeted Content

It has been found that internet viewers usually focus on the content on the page and ignore the areas used for advertising. Eyeball tracking tests carried out on internet viewers have found that internet viewers rarely look at the advertisements on an internet web page. Thus, it logically follows that the internet viewers rarely interact with those advertisements that the internet viewers don't even look at. Thus, internet viewers have become accustomed to avoiding internet banner advertisements. When asked, the internet viewers state that they find most internet banner advertisements to be un-interesting and irrelevant to their interests.

To increase the effectiveness of internet advertisements, the present invention seeks to more fully engage internet viewers with internet advertisements and the areas of web pages normally used for displaying internet advertisements. Specifically, the motivation behind the invention is to draw the attention of internet viewers towards internet advertisement locations in general by delivering targeted content or a combination of advertisement and content to the internet viewers on an intermittent basis.

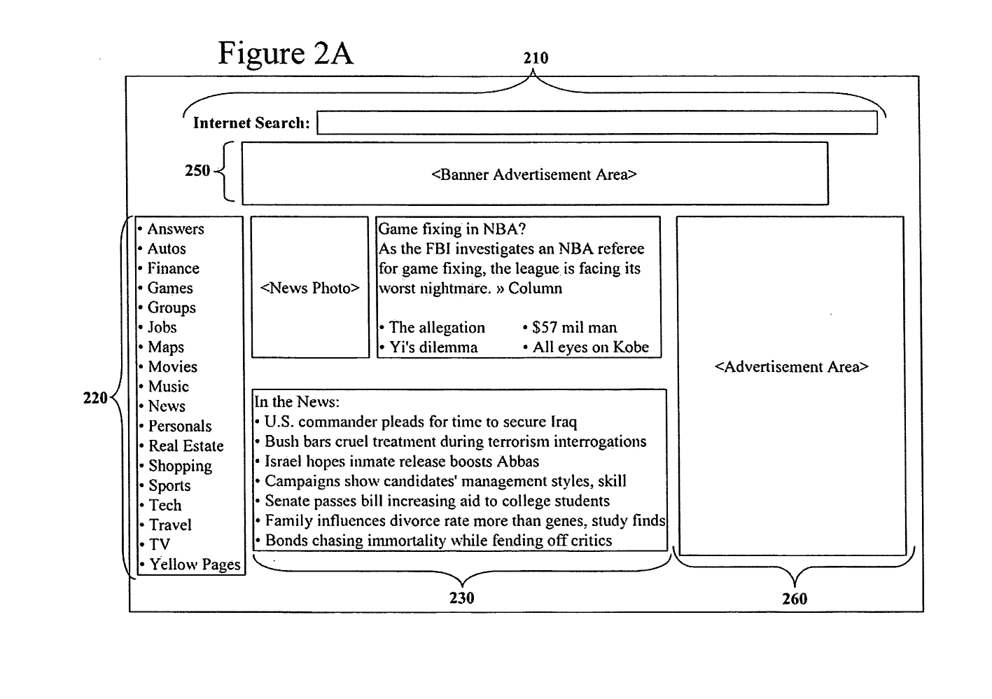

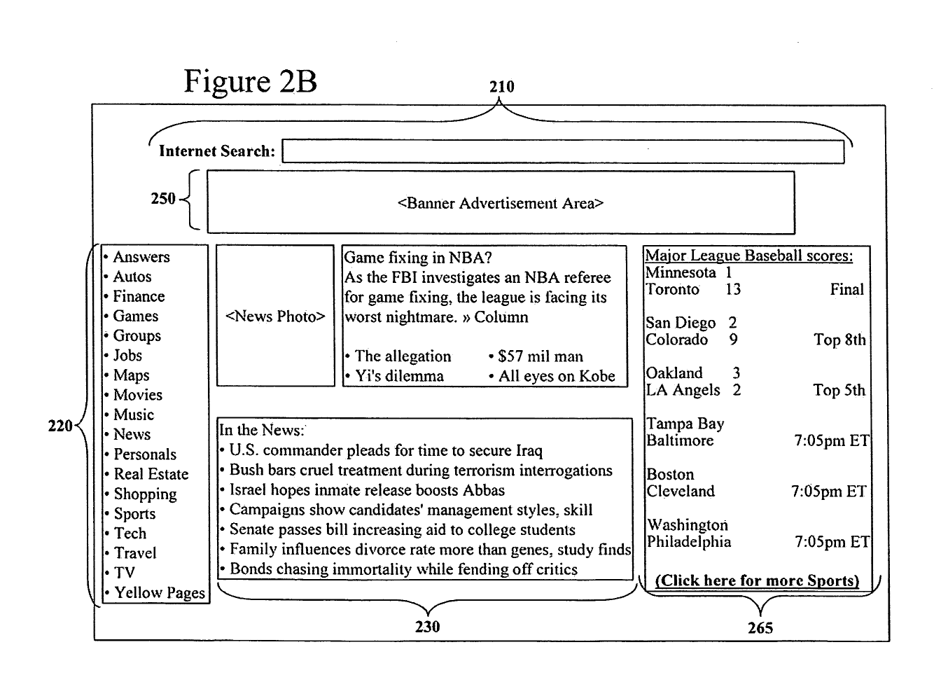

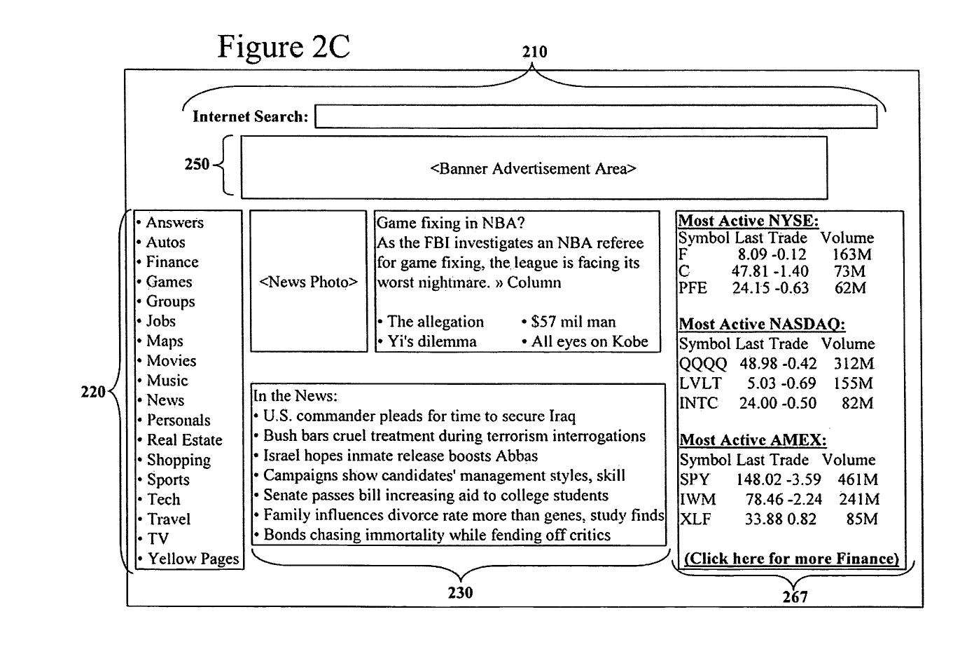

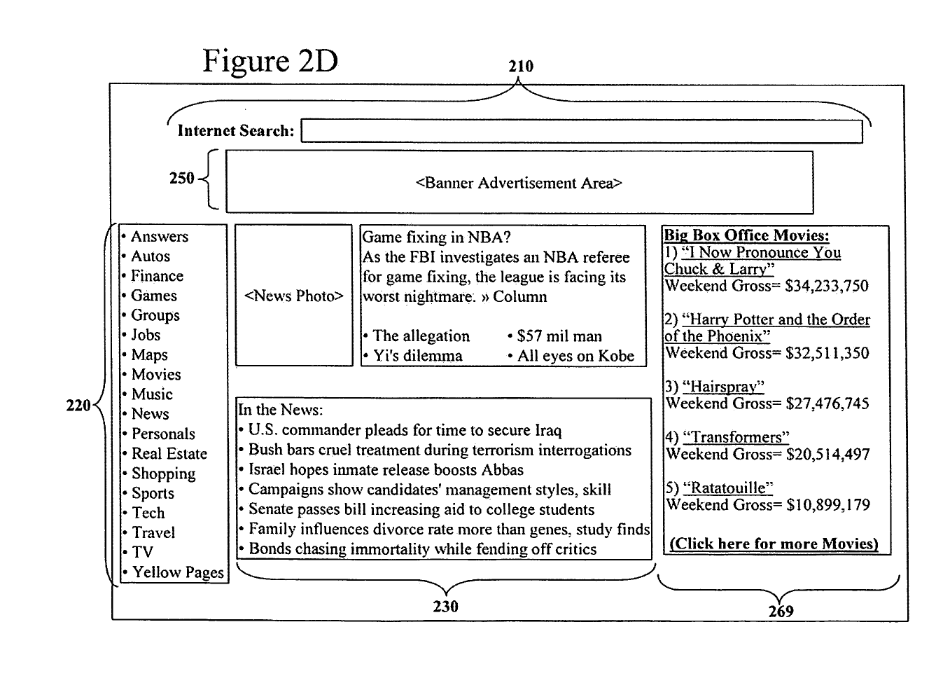

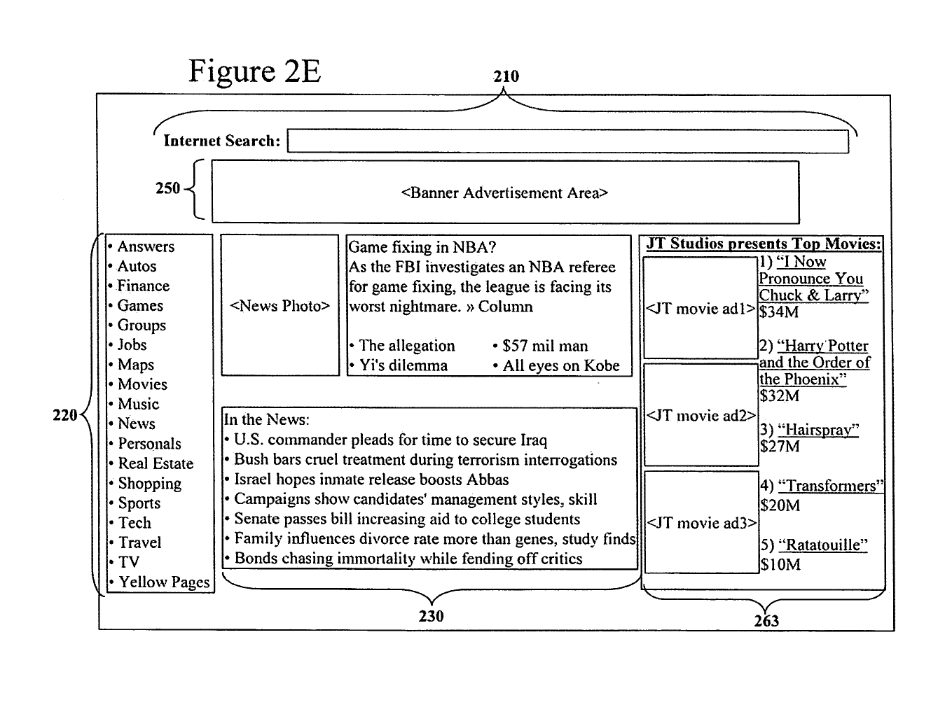

FIG. 2A illustrates an example of an “internet portal” web site home page. An internet portal is a web site that offers internet viewers easy access to multiple popular internet content and services. In the internet portal screen display of FIG. 2A an internet search field 210 is presented to allow internet viewers to search the World Wide Web, a set of news stories 230 is displayed to provide interesting content, and a large list of popular internet services 220 is provided to allow the internet viewer easy access to those popular services.

To support the operation of the internet portal illustrated in FIG. 2A, a banner advertisement 250 is displayed near the top of the screen and another advertisement area 260 is displayed on the right side of the screen. If the exact same web page layout is always used, which internet viewers like because it is familiar and they can easily find what they want, then the internet viewers will begin to complete ignore banner advertisement 250 and advertisement area 260. Instead, the internet viewers will simply look at and interact with the services or content that they came to the internet portal to access. This will cause low click through rates and low exposure to the internet advertisements.

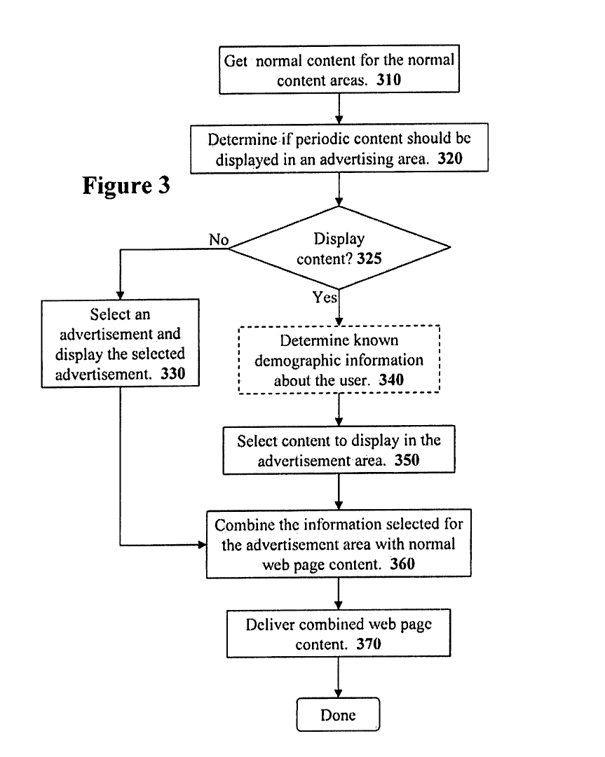

To prevent having, internet viewers completely ignore the areas that normally contain advertisements, the present invention proposes a system of intermittently displaying engaging content into those areas. The system will be disclosed with reference to the how diagram presented in FIG. 3.

Referring to FIG. 3, the first step is to get the normal content for the normal content areas. With reference to FIG. 2A, this may include the popular internet services area 220 and the news headlines area 230.

Next, at steps 320 and 325, the system determines if content should be displayed in an advertising area. This determination may be made in many different manners. For example, the system may simply randomly determine when content should be displayed in an area normally used for advertising.

Other more complex determination methods may also be used. In one embodiment, the click-through rate of the specific internet viewer may be consulted and if the internet viewer has a very low click-through rate then content may be displayed on a more frequent basis in order to attempt to engage the internet viewer. If an internet viewer is already known to click on advertisements, then advertisements may be displayed to the internet viewer on a more frequent basis. Furthermore, it the internet viewer appears to be a new viewer of this web site or a web site viewer that has not used many of the other services offered by the web site, the system may increase the probability of displaying content from one of those other services offered by the web site in order to introduce those services to the internet viewer.

If the system determines than an advertisements should be displayed as normal then the system proceeds to step 330 to select an advertisement for display. The advertisement selection may use content match techniques or internet viewer demographics as are well-known in the art.

Instead, if the system determines that content should be displayed in the advertisement area, then the system may proceed to step 340 to retrieve the known demographic information about the internet viewer. Various different types of information may be known about an internet viewer. If the internet viewer has registered with the web site and provided demographic information such as sex, age, address, etc. then that information can be retrieved. Even if the internet viewer has not registered with the web site, various bits of information can be deduced about the internet viewer. For example, the system may perform an internet protocol (IP) address to geographic location look-up that may provide an approximate geographic location of the internet viewer. Similarly, the system may be able to determine some of the web sites that the internet viewer has previously visited.

Next, at step 350, the system selects interesting content to display to the internet viewer. If the demographic information about the internet viewer was obtained in optional step 340 then that demographic information about the internet viewer may be used to help select content that will be very likely to appeal to that internet viewer. For example, if it is known that the internet viewer is an avid baseball fan then the system may display a set of Major League Baseball scores as content for that internet viewer.

There are countless examples of manners in which the content can be selected to appeal to the internet viewer. If an internet viewer has show an interest in movies, then the system may select the top 3 movies of the week. If an internet viewer has entered in set of stock symbols for a stock portfolio to track then the system may display the current stock prices of the stocks in that portfolio. If the stock portfolio is very large then the system may select the top gainers and losers from the internet viewers's portfolio.

If the internet viewer has uploaded some of the internet viewer's own content then the system may reflect back some of that content to the internet viewer in a manner to keep the internet viewer engaged. For example, if the internet viewer has uploaded some digital photos to digital photo web site then the system may display images of example mousepads, coffee cups, T-shirts, and calendars that may be purchased with the internet viewers's own pictures on the products. Similarly, the internet viewer's most recent blog (weblog) entries may be displayed as means of reminding the internet viewer as to what their most recent blog posting contains.

In one embodiment, the content that may be displayed can be controlled or influenced by the internet viewer through internet viewer settable options. These internet viewer settings may also influence what is shown in the advertisements. Although it may seem counter-intuitive to have internet viewer specifying their advertising preferences, internet viewer would rather be exposed to relevant advertisements than completely irrelevant and uninteresting advertisements. Internet viewer customizations can enhance the information already known about the internet viewer such as the internet viewer's IP address and ZIP code. Internet viewer settings allow them to engage further with the advertisement placement. Examples of possible internet viewer settings include internet viewer's hobbies, internet viewer's entertainment interests, internet viewer's business profession, and any other information that would be useful in determine what content and advertisements would most appeal to the internet viewer.

After selecting an advertisement in step 330 or some engaging content at step 350, the system merges the information selected for the area normally reserved for advertisements with the remainder of the normal web page content at step 360. The final merged result is delivered to the internet viewer at step 370.

FIG. 2B, illustrates how the web site home page may appear if Major League Baseball scores were selected in step 350. By placing content that is appealing to the internet viewer in the area normally used for advertisements, Major League Baseball scores in this example, the present invention will get internet viewers to not ignore that screen area that is normally used for advertisements.

### Capitalizing on the Content Displayed

Although the main goal of displaying engaging content in an area normally used for advertisements is to prevent internet viewers from completely ignoring that area, one may also achieve various other benefits of putting engaging content in that area. In this manner, more than one goal will be accomplished.

The home page of a web site often has links to other web pages and services available from the web site's publisher. For example, FIG. 2A illustrates an internet portal web page with a large list of popular internet services 220 that are offered by the web site's publisher on the left-hand side of the screen display. With the system of the present invention, the portal web site publisher may use an area normally used for displaying advertisements to both provide interesting content to engage the internet viewer and provide the internet viewer information about the other services and content that are offered by the web site publisher.

For example, FIG. 2B illustrates an area normally used for advertisements containing a list of Major League Baseball scores 265. At the bottom of that list is a hyperlink labeled “Click here for more Sports”. That link may bring the internet viewer to the same Sports service listed in list of popular internet services 220 in the left-hand column of FIG. 2B. Thus, the list of Major League Baseball scores 265 serve both as a means to draw the internet viewer's attention to an area normally used for advertisements and as a means to draw internet viewers to another of the web site publisher's services.

FIG. 2C illustrates another example of using an area normally devoted to advertisements as an informative content area and as a means to draw internet viewers to another property of the web site publisher. In the example of FIG. 2C, the area normally devoted to advertisements is displaying a list 267 of the three most active stocks on the three most popular stock markets in the United States of America. At the bottom of that list 267 is a link that the internet viewer may click on to direct the internet viewer to the ‘Finance’ web site listed in the list of popular internet services 220.

FIG. 2D illustrates yet a third example of using an area normally reserved for advertisements as an area for engaging content intended to draw internet viewers to another property of the web site publisher. In the example of FIG. 2D, the area normally devoted to advertisements is displaying a list 269 of the five most popular recent movies and their weekend box office gross revenues. At the bottom of that list 267 is a link that the internet viewer may click on to direct the internet viewer to the “Movies” web site listed in the list of popular internet services 220.

### Customizing the Content Links

As illustrated in FIGS. 2B, 2C, and 2D the advertising area can be used to give the internet viewer a small taste as to what information is available in the web site publisher's other web properties and an easy means of clicking to that other web property. To further draw the interest of internet viewers, the links in that content area may be customized specifically for that internet viewer.

For example, with reference to the ‘Movies’ example of FIG. 2D, each movie in the list may be encoded with a link to a movie ticket web site that includes the title of the movie and the postal zip code of the internet viewer such that if the internet viewer clicks on the movie title, the internet viewer will be directed to a listing of theatrical screenings of that movie in the internet viewer's local area. This may be done using an internet protocol (IP) address to zip code look-up table as is well-known in the art.

### Leveraging a Search Engine

As set forth in the previous section, one may customize the links from the content in a manner that will appeal to the internet viewer. However, this may not always be easy to accomplish if there is not enough information known about the internet viewer. An IP address-to-geographic location look-up table will not always be able to provide a ZIP code for every IP address.

To handle instances wherein it is difficult to customize a link for an internet viewer, a search engine may be used instead to provide relevant additional information. For example, referring back to FIG. 2D, if no ZIP code is available for a internet viewer then each movie title may be linked to a search engine web site with a search request to be performed on the movie title. Thus, if an internet viewer clicks on “Harry Potter and the Order of the Phoenix” then the next web page to be displayed may be the search engine results for an internet search using the keywords “Harry Potter and the Order of the Phoenix”.

In most cases, such a search should provide good results to internet viewer. However, to further refine the search the search link may include additional keywords that provide better context for the search. Referring again to the example of FIG. 2D, each search link from the movie content area 269 may further include the keyword “movie” in order to provide better search results since it is known that the all of the information in that area pertains to movies. Thus, when the internet viewer clicks on the link for the movie “Hairspray” the search will be performed using keywords “Hairspray movie”. This will provide a much more relevant result than if an internet search was performed on the keyword “hairspray”. Even when there are a number of keywords such that an accurate result might be given as with the keywords “Harry Potter and the Order of the Phoenix”, the addition of a context keyword may provide better results since the addition of the word “movie’ may filter out search results that pertain to the book of the same name.

Any other information that may be useful may also be provided to the search engine. For example, if the ZIP code of an internet user is not known but their city and state is known then that information may be passed to the search engine to narrow the search. Specifically, a search link from the previous paragraph's example could specify “movie hairspray santa clara, CA” in order to obtain information about local theatrical showings of the movie ‘hairspray’ for an internet viewer located in Santa Clara, California.

### A Method of Easily Obtaining Content

The previous sections describe how using small snippets of interesting content can keep internet users engaged with areas of the screen normally devoted to advertising. However, it is not trivial to develop a means of automatically extracting small amounts of content from a larger information source.

One method of handling this issue is to use a new technology known as RSS or Really Simple Syndication. RSS is a mark-up language used to publish frequently updated content such as blog entries, news headlines or podcasts. An RSS document (also known as a feed or web feed) generally contains a summary of content from an associated web site. Many web sites already provide RSS feeds so that their readers can keep up with their favorite web sites in an automated manner that's easier than repeatedly manually checking the web sites. Using an RSS feed means that the content will be recent and it will be pre-summarized into small chunks that will be ideal for a small advertising area.

Thus, a customized RSS reader may be used to implement a module for filling in advertising areas with engaging content. The customized RSS reader would receive an address for the RSS feed to be used. Using the RSS feed address, the customized RSS reader would then extract enough content from the RSS feed to fill the small advertising area. Finally, the customized RSS reader would then add links (or revise existing links) to the RSS feed content such that an internet viewer that clicks on the content will be redirected.

The links could be added in many different manners as set forth in the previous sections. In a very simple system, the link may direct the internet viewer may to the web site the provided the content. When information is known about the internet viewer, the link may be customized in a manner that will provided customized information for that internet viewer (such as local movie listings or local weather). Alternatively, the customized RSS reader may create links that direct the user to a search engine using keywords from the RSS feed content and perhaps a context keyword derived from the type of web site the RSS feed is from. Thus, RSS provides a generic capability to extract content from different kinds of web sites providing a scalable approach in displaying content.

It should be emphasized that RSS feeds are only one possible method of implementing the teachings of the present invention. One may also use customized XML, JSON or another similar pre-defined data format to get content from different web sites.

In yet other embodiments, one may use information from wireless access protocol servers (WAP) or a proxy server that normally provides web access to cellular telephones. Cellular telephones typically have small display screens such that cellular telephones are not well suited for browsing web pages normally accessed with a personal computer. To handle this problem, web sites often run parallel WAP servers that specialize in providing web site information in a format created for such small devices. Similarly, there are proxy servers that will access normal web sites but then reformat the data in a manner suited for a small display screen. Since an advertising area may be very small like a cellular telephone screen, the same technology can be used to create displays for advertising areas.

### Hybrid Advertisements and Content

Instead of just displaying interesting content in an advertising area on an intermittent basis one embodiment of the present invention proposes mixing advertising with interesting content. In this manner, internet viewers will be drawn to advertisements by the content that is displayed in a manner mixed in with the advertisements. This content module can be scheduled as an independent ad targeted to the right kind of users depending on the topic of content. Advertisers that want to boost user engagement with their ads can also sign up to show relevant content inside their ad units.

With a hybrid advertisement and content system, various advertisers may choose to ‘sponsor’ some content since it builds goodwill with customers by providing the customers with informational content that the users desire. FIG. 2E illustrates an example of mixed content and advertisement.

In the screen display of FIG. 22E, advertisement area 263 contains a mix of advertisement and content. Specifically, advertisement area 263 contains a header stating “JT Studios presents Top Movies” indicating that JT studios is sponsoring the list of the current top 5 movies presented in a column along the right side. However, advertisement area 263 also contains three graphical advertisements for three movies put out by JT studios. In this manner, JT studios will receive goodwill from customers by providing desirable content and they will simultaneously viewers users to view their movie advertisements by drawing viewers to the interesting content presented. Although FIG. 2E presents an example with reference to movies, the same type of principal can be used for any other type of products and services.

In one embodiment, advertisers may specify that advertisements be displayed in normal form some of the time and in hybrid form at other times. The advertisers may adjust the mixture of content and advertising content in order to obtain a desired amount of engagement with internet viewers.

The foregoing has described a number of techniques for engaging users with advertisement areas using interesting content. It is contemplated that changes and modifications may be made by one of ordinary skill in the art, to the materials and arrangements of elements of the present invention without departing from the scope of the invention.

We claim:

1. A method of selecting and displaying information on the world wide web, said method comprising the steps of:
determining in an area normally devoted to advertisements should be replaced with engaging content for an internet viewer; and
selecting said engaging content for said internet viewer when said area normally devoted to advertisements will be replaced with engaging content.

2. The method of selecting and displaying information on the world wide web as set forth in claim 1 wherein said step of determining if an area normally devoted to advertisements should be replaced with engaging content comprises making a random determination.

3. The method of selecting and displaying information on the world wide web as set forth in claim 1 wherein selecting said engaging content comprises consulting demographic information known about said internet viewer.

4. The method of selecting and displaying information on the world wide web as set forth in claim 3 wherein said demographic information comprises a geographic location determined using an internet protocol address.

5. The method of selecting and displaying information on the world wide web as set forth in claim 3 wherein said demographic information comprises information provided by said internet viewer when registering with a web site.

6. The method of selecting and displaying information on the world wide web as set forth in claim 3 wherein said demographic information comprises past browsing history of said internet viewer.

7. The method of selecting and displaying information on the world wide web as set forth in claim 1 wherein said engaging content for said internet viewer comprises a subset of an RSS feed of a web site.

8. The method of selecting and displaying information on the world wide web as set forth in claim 1 wherein said engaging content for said internet viewer comprises a hybrid mix of advertisement and content

9. The method of selecting and displaying information on the world wide web as set forth in claim 1 wherein said engaging content for said internet viewer comprises links to direct said internet viewer to customized content.

10. The method of selecting and displaying information on the world wide web as set forth in claim 1 wherein said engaging content for said internet viewer comprises links to direct said internet viewer to a search engine with a search using information from said engaging content.

11. The method of selecting and displaying information on the world wide web as set forth in claim 1 wherein said engaging content for said internet viewer comprises links to direct said internet viewer to a related web site.

12. The method of selecting and displaying information on the world wide web as set forth in claim 11 wherein said engaging content for said internet viewer comprises links customized based on information known about said internet viewer.

13. A computer readable medium, said computer readable medium comprising a set of computer instructions for selecting and displaying information on the world wide web, said computer instructions implementing the steps of:
determining if an area normally devoted to advertisements should be replaced with engaging content for an internet viewer; and
selecting said engaging content for said internet viewer when said area normally devoted to advertisements will be replaced with engaging content.

14. The computer readable medium as set forth in claim 12 wherein said step of determining if an area normally devoted to advertisements should be replaced with engaging content comprises making a random determination.

15. The computer readable medium as set forth in claim 12 wherein selecting said engaging content comprises consulting demographic information known about said internet viewer.

16. The computer readable medium as set forth in claim 15 wherein said demographic information comprises information provided by said internet viewer when registering with a web site.

17. The computer readable medium as set forth in claim 12 wherein said engaging content for said internet viewer comprises a subset of an RSS feed of a web site.

18. The computer readable medium as set forth in claim 12 wherein said engaging content for said internet viewer comprises a hybrid mix of advertisement and content

19. The computer readable medium as set forth in claim 12 wherein said engaging content for said internet viewer comprises links to direct said internet viewer to customized content.

20. The computer readable medium as set forth in claim 12 wherein said engaging content for said internet viewer comprises links to direct said internet viewer to a search engine with a search using information from said engaging content.
